(19) United States
(12) Patent Application Publication
(10) Pub. No.: US 2026/0331096 A1
(43) Pub. Date: Oct. 22, 2026

(54) SPEECH DATA-BASED SCRIPT PROCESSING APPARATUS

(71) Applicants: Jae Ho CHOI, Seoul (KR); DELTA PDS CO., LTD., Seoul (KR)

(72) Inventor: Jae Ho CHOI, Seoul (KR)

(73) Assignee: DELTA PDS CO., LTD., Seoul (KR)

(21) Appl. No.: 19/468,096

(22) Filed: Feb. 3, 2026

(30) Foreign Application Priority Data
Feb. 6, 2025 (KR) 10-2025-0015345

(51) Int. Cl. G10L 15/06; G10L 15/18

(52) U.S. Cl. CPC G10L 15/063; G10L 15/1815

(57) ABSTRACT

A speech data-based script processing apparatus includes: a speech data receiving unit configured to receive user speech data; a script conversion and summarization unit configured to convert the speech data into a script and to generate a summary by inputting the script into an artificial intelligence script model; a summary error processing unit configured to modify errors in the summary through user control; and a script error processing unit configured to modify errors in the script by feeding back the errors of the summary to the script model.

### CROSS-REFERENCE TO RELATED APPLICATIONS

This application claims priority to and the benefit of Korean Patent Application No. 10-2025-0015345, filed on Feb. 6, 2025, disclosures of which are incorporated herein by reference in its entirety.

### TECHNICAL FIELD

The present disclosure relates to speech data processing and natural language processing (NLP) technologies, and more particularly, to a speech data-based script processing apparatus and method for converting speech data into a script, detecting and correcting errors in the converted script, and feeding back the corrected data to improve conversion accuracy through artificial intelligence (AI) learning.

### BACKGROUND

Speech recognition systems are technologies that convert a user's speech into text for recording, and are utilized in fields such as preparation of meeting minutes, lecture transcription, and automatic subtitle generation. Conventional speech recognition systems operate in a manner of converting speech into a script and then generating a summary based on the script.

However, in conventional speech recognition systems, typographical errors and semantic errors may occur during a conversion process due to factors such as pronunciation, intonation, and background noise. When accuracy of the script is degraded, the same errors may be reflected in the summary generated based on the script. In addition, even when a user modifies the summary, the modified content is not automatically reflected in the original script, and thus the user has to separately modify the script and the summary.

Further, conventional systems have limited functions for continuously improving conversion accuracy by reflecting user feedback. Since errors of the script and errors of the summary are independently corrected, the same errors may be repeatedly generated, and the user may bear a burden of repeatedly reviewing and correcting converted results.

Accordingly, there is a demand for a technology capable of maintaining consistency between a converted script and a summary and improving conversion accuracy by reflecting user feedback.

Korean Patent No. 10-2091684 (Mar. 16, 2020) discloses a modification method and an apparatus implementing the method, which adopt a scheme in which a user directly issues a modification command to clearly distinguish between a case of text modification and a case of text addition input without error, and to maximize user convenience in a modification operation according to the modification command.

A speech recognition text modification method by an electronic device includes determining a correct modification target text by changing a previously input modification target text to a modification text input through speech recognition after receiving a standby command for modification target text input from a user, and, upon receiving a modification command, selecting a text or a partial text that satisfies a correlation calculation score according to a preset condition as a modification candidate text by calculating a correlation between the determined modification target text and an existing modification target text or a portion thereof, and then replacing and inputting the determined modification target text.

### Prior Art References

### Patent Document

Patent Document 1: Korean Patent No. 10-2091684 (Mar. 16, 2020)

### SUMMARY

One embodiment of the present invention provides a speech data-based script processing apparatus capable of converting speech data into a script, detecting and correcting errors in the converted script, and feeding back corrected data to improve conversion accuracy through artificial intelligence (AI) learning.

One embodiment of the present invention provides a speech data-based script processing apparatus capable of receiving user speech data, converting the user speech data into a script, and improving conversion accuracy by analyzing speech characteristics including pronunciation, intonation, and speed.

One embodiment of the present invention provides a speech data-based script processing apparatus capable of generating a summary by inputting a converted script into an artificial intelligence script model, and reflecting evaluation results obtained by analyzing grammatical errors and semantic errors.

One embodiment of the present invention provides a speech data-based script processing apparatus capable of supporting a user to modify errors in a summary, distinguishing syntax errors and semantics errors using style texts including color, underline, and highlight, and recommending phrases to be modified by utilizing speech input.

One embodiment of the present invention provides a speech data-based script processing apparatus capable of automatically correcting errors in an original script by reflecting a modified summary, and detecting and correcting errors occurring in subsequent conversion processes by learning modified data.

In one embodiment, a speech data-based script processing apparatus includes: a speech data receiving unit configured to receive user speech data; a script conversion and summarization unit configured to convert the speech data into a script and to generate a summary by inputting the script into an artificial intelligence script model; a summary error processing unit configured to modify errors in the summary through user control; and a script error processing unit configured to modify errors in the script by feeding back the errors of the summary to the script model.

The script conversion and summarization unit may be configured to convert the script into an embedding vector through the artificial intelligence script model, analyze syntax and semantics of the script through the embedding vector, evaluate a possibility of errors in the summary, and generate the summary by reflecting a result of the evaluation.

The script conversion and summarization unit may be configured to convert the script into multi-dimensional embedding vectors through the artificial intelligence script model, and to identify a possibility of syntax errors of the script by analyzing a specific dimension of the multi-dimensional embedding vectors.

The script conversion and summarization unit may be configured to evaluate a possibility of semantics errors of the script based on distances between the multi-dimensional embedding vectors, and to score a possibility of errors of the script by combining results of the syntax and semantics analyses.

The script conversion and summarization unit may be configured to reflect an evaluation result of syntax of the script as a first style text in a specific phrase of the summary, and to reflect semantics of the script as a second style text in a specific section of the summary.

The summary error processing unit may be configured to manually modify a syntax error phrase of the summary by receiving user input.

The summary error processing unit may be configured to receive an explanation through user speech, recommend at least one modified text for a semantics error phrase of the summary, and automatically modify the second style text.

The script error processing unit may be configured to feed back errors of the summary to the artificial intelligence script model and to reflect conversion errors according to user speech characteristics in the artificial intelligence script model.

The script error processing unit may be configured to feed back a specific phrase according to a syntax error of the summary and a specific section according to a semantics error of the summary to the artificial intelligence script model, such that the artificial intelligence script model automatically detects the conversion errors.

The script error processing unit may be configured such that the artificial intelligence script model automatically modifies the script and the summary based on automatic detection of the conversion errors.

The script error processing unit may be configured to derive speech characteristics based on intonation, pronunciation, or speed analyzed through the user speech data during the feedback process, and to reflect the speech characteristics as training data of the artificial intelligence script model.

The script error processing unit may be configured to update the artificial intelligence script model based on an original script and a modified script.

In one embodiment, a speech data-based script processing method performed in a speech data-based script processing apparatus, the method includes receiving user speech data, converting the speech data into a script and generating a summary by inputting the script into an artificial intelligence script model, modifying errors in the summary through user control; and modifying errors in the script by feeding back the errors of the summary to the script model.

The step of converting the speech data into the script and generating the summary may include converting the script into an embedding vector through the artificial intelligence script model, analyzing syntax and semantics of the script through the embedding vector, evaluating a possibility of errors in the summary, and generating the summary by reflecting a result of the evaluation.

The step of modifying the errors in the summary may include manually modifying a syntax error phrase of the summary by receiving user input.

The step of modifying the errors in the script may include feeding back errors of the summary to the artificial intelligence script model and reflecting conversion errors according to user speech characteristics in the artificial intelligence script model.

### ADVANTAGEOUS EFFECTS

The disclosed technology may have the following effects. However, this does not mean that a specific embodiment must include all of the following effects or must include only the following effects, and therefore, the scope of rights of the disclosed technology should not be understood as being limited thereby.

One embodiment of the present invention provides a speech data-based script processing apparatus capable of converting speech data into a script, detecting and correcting errors in the converted script, and feeding back corrected data to improve conversion accuracy through artificial intelligence (AI) learning.

One embodiment of the present invention provides a speech data-based script processing apparatus capable of receiving user speech data, converting the user speech data into a script, and improving conversion accuracy by analyzing speech characteristics including pronunciation, intonation, and speed.

One embodiment of the present invention provides a speech data-based script processing apparatus capable of generating a summary by inputting a converted script into an artificial intelligence script model, and reflecting evaluation results obtained by analyzing grammatical errors and semantic errors.

One embodiment of the present invention provides a speech data-based script processing apparatus capable of supporting a user to modify errors in a summary, distinguishing syntax errors and semantics errors using style texts including color, underline, and highlight, and recommending phrases to be modified by utilizing speech input.

One embodiment of the present invention provides a speech data-based script processing apparatus capable of automatically correcting errors in an original script by reflecting a modified summary, and detecting and correcting errors occurring in subsequent conversion processes by learning modified data.

### BRIEF DESCRIPTION OF THE DRAWINGS

FIG. 1 is a diagram illustrating a speech data-based script processing system according to one embodiment of the present invention.

FIG. 2 is a diagram illustrating a system configuration of the speech data-based script processing apparatus of FIG. 1.

FIG. 3 is a diagram illustrating a functional configuration of the speech data-based script processing apparatus of FIG. 1.

FIG. 4 is a flowchart illustrating a speech data-based script processing method performed by the speech data-based script processing apparatus of FIG. 1.

FIG. 5 is a diagram illustrating a script conversion and error correction process and an automatic correction process through AI learning performed by the speech data-based script processing apparatus of FIG. 1.

### DETAILED DESCRIPTION

Since the description of the present disclosure is merely an embodiment for illustrating structural or functional description, it should not be interpreted that the technical scope of the present disclosure is limited by the embodiments described in this document. In other words, embodiments may be modified in various ways and implemented in various forms; therefore, it should be understood that various equivalents realizing technical principles of the present disclosure belong to the technical scope of the present disclosure. Also, since it is not meant that a specific embodiment should support all of the purposes or effects intended by the present disclosure or include only the purposes or effects, the technical scope of the present disclosure should not be regarded as being limited to the descriptions of the embodiment.

Meanwhile, implication of the terms used in this document should be understood as follows.

The terms such as “first” and “second” are introduced to distinguish one element from the others, and thus the technical scope of the present disclosure should not be limited by those terms. For example, a first element may be called a second element, and similarly, the second element may be called the first element.

Suppose a constituting element is said to be “connected” to another constituting element. In that case, the former may be connected to the latter element directly, but it should be understood that a third constituting element may be present between the two elements. On the other hand, if a constituting element is said to be “directly connected” to another constituting element, it should be understood that there is no other constituting element present between the two elements. Meanwhile, other expressions describing a relationship between constituting elements, namely “between” and “right between” or “adjacent to” and “directly adjacent to” should be interpreted to provide the same implication.

A singular expression should be understood to indicate a plural expression unless otherwise explicitly stated. The term “include” or “have” is used to indicate existence of an embodied feature, number, step, operation, constituting element, component, or a combination thereof; and should not be understood to preclude the existence or possibility of adding one or more other features, numbers, steps, operations, constituting elements, components, or a combination thereof.

Identification symbols (e.g., a, b, and c) for individual steps are used for the convenience of description. The identification symbols are not intended to describe an operation order of the steps. Therefore, unless otherwise explicitly indicated in the context of the description, the steps may be executed differently from the stated order. In other words, the respective steps may be performed in the same order as stated in the description, actually performed simultaneously, or performed in reverse order.

The present disclosure may be implemented in the form of program code in a computer-readable recording medium. A computer-readable recording medium includes all kinds of recording devices that store data that a computer system may read. Examples of a computer-readable recording medium include a ROM, a RAM, a CD-ROM, a magnetic tape, a floppy disk, and an optical data storage device. Also, the computer-readable recording medium may be distributed over computer systems connected through a network so that computer-readable code may be stored and executed in a distributed manner.

Unless defined otherwise, all the terms used in the present disclosure provide the same meaning as understood generally by those skilled in the art to which the present disclosure belongs. Those terms defined in ordinary dictionaries should be interpreted to have the same meaning as conveyed in the context of related technology. Unless otherwise defined explicitly in the present disclosure, those terms should not be interpreted to have ideal or excessively formal meaning.

Since the description of the present disclosure is merely an embodiment for illustrating structural or functional description, it should not be interpreted that the technical scope of the present disclosure is limited by the embodiments described in this document. In other words, embodiments may be modified in various ways and implemented in various forms; therefore, it should be understood that various equivalents realizing technical principles of the present disclosure belong to the technical scope of the present disclosure. Also, since it is not meant that a specific embodiment should support all of the purposes or effects intended by the present disclosure or include only the purposes or effects, the technical scope of the present disclosure should not be regarded as being limited to the descriptions of the embodiment.

Meanwhile, implication of the terms used in this document should be understood as follows.

The terms such as “first” and “second” are introduced to distinguish one element from the others, and thus the technical scope of the present disclosure should not be limited by those terms. For example, a first element may be called a second element, and similarly, the second element may be called the first element.

Suppose a constituting element is said to be “connected” to another constituting element. In that case, the former may be connected to the latter element directly, but it should be understood that a third constituting element may be present between the two elements. On the other hand, if a constituting element is said to be “directly connected” to another constituting element, it should be understood that there is no other constituting element present between the two elements. Meanwhile, other expressions describing a relationship between constituting elements, namely “between” and “right between” or “adjacent to” and “directly adjacent to” should be interpreted to provide the same implication.

A singular expression should be understood to indicate a plural expression unless otherwise explicitly stated. The term “include” or “have” is used to indicate existence of an embodied feature, number, step, operation, constituting element, component, or a combination thereof; and should not be understood to preclude the existence or possibility of adding one or more other features, numbers, steps, operations, constituting elements, components, or a combination thereof.

Identification symbols (e.g., a, b, and c) for individual steps are used for the convenience of description. The identification symbols are not intended to describe an operation order of the steps. Therefore, unless otherwise explicitly indicated in the context of the description, the steps may be executed differently from the stated order. In other words, the respective steps may be performed in the same order as stated in the description, actually performed simultaneously, or performed in reverse order.

The present disclosure may be implemented in the form of program code in a computer-readable recording medium. A computer-readable recording medium includes all kinds of recording devices that store data that a computer system may read. Examples of a computer-readable recording medium include a ROM, a RAM, a CD-ROM, a magnetic tape, a floppy disk, and an optical data storage device. Also, the computer-readable recording medium may be distributed over computer systems connected through a network so that computer-readable code may be stored and executed in a distributed manner.

Unless defined otherwise, all the terms used in the present disclosure provide the same meaning as understood generally by those skilled in the art to which the present disclosure belongs. Those terms defined in ordinary dictionaries should be interpreted to have the same meaning as conveyed in the context of related technology. Unless otherwise defined explicitly in the present disclosure, those terms should not be interpreted to have ideal or excessively formal meaning.

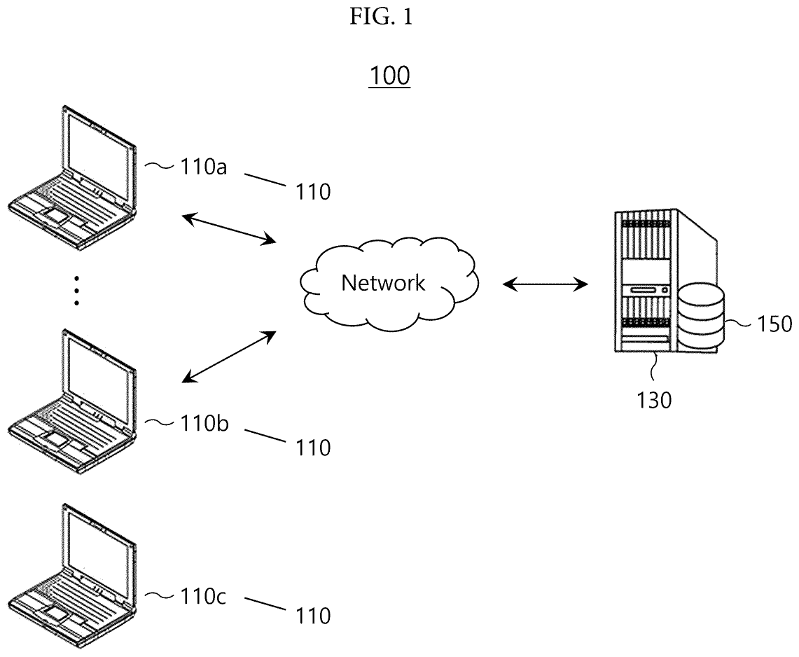

FIG. 1 is a diagram illustrating a speech data-based script processing system according to one embodiment of the present invention.

Referring to FIG. 1, the speech data-based script processing system 100 may include a plurality of user terminals 110, a speech data-based script processing apparatus 130, and a database 150.

The user terminal 110 may correspond to a computing device operated by a user. For example, the user terminal 110 may be implemented as a desktop computer, a laptop computer, a tablet PC, or a smartphone, but is not limited thereto, and may be implemented as various types of devices.

The user terminal 110 may include at least one of a first user terminal 110a, a second user terminal 110b, and a third user terminal 110c. For convenience, the first user terminal 110a may be used by a first user, the second user terminal 110b may be used by a second user, and the third user terminal 110c may be used by a third user.

The user terminal 110 may be independently operated by each user, and depending on a user environment, a speech input method and a data processing method may be implemented differently.

In addition, the user terminal 110 may classify speech data according to a user request and may be configured to be utilized for a specific purpose. The user may classify speech data according to purposes such as preparation of meeting minutes, lecture transcription, and personal memo, and a converted script may be stored and managed according to a configured classification.

The user terminal 110 may be implemented as a mobile terminal, and may be connected to the speech data-based script processing apparatus 130 through a wireless network so as to transmit speech data and receive a converted script. The mobile terminal may transmit and receive speech data using cellular communication or Wi-Fi, and speech input may be possible even while moving. In addition, the user terminal 110 may be operated in a desktop environment, and may be connected to the speech data-based script processing apparatus 130 through a wired network or the Internet.

The speech data-based script processing apparatus 130 may correspond to a computing device connectable to the user terminal 110 through a network. In one embodiment, the speech data-based script processing apparatus 130 may receive speech data input from the user terminal 110, convert the received speech data into a script, and generate a summary based on the converted script.

In one embodiment, the speech data-based script processing apparatus 130 may be linked with the user terminal 110 through a dedicated interface module installed in the user terminal 110. The dedicated interface module may transmit speech data input from the user terminal 110 to the script processing apparatus 130 with user approval, and may provide the converted script and the summary to the user terminal 110.

Meanwhile, the connection and coupling between the speech data-based script processing apparatus 130 and the user terminal 110 described herein may correspond to one embodiment, and it should be understood that the connection and coupling may be modified and applied in various forms within a normal scope depending on various operation and implementation environments.

The database 150 may correspond to a storage device that stores various information required during operation of the speech data-based script processing apparatus 130. For example, the database 150 may store speech data input from a user, converted scripts, generated summaries, and modified script data. In addition, the database 150 is not limited thereto, and may store intermediate data generated during a process in which the speech data-based script processing apparatus 130 converts speech data according to a user request, or may accumulate learning data reflecting user feedback to store various types of data collected or generated during a script conversion process.

In addition, in FIG. 1, the database 150 is illustrated as a logical storage device included in the speech data-based script processing apparatus 130, but is not limited thereto, and may be implemented as a device independent from the speech data-based script processing apparatus 130.

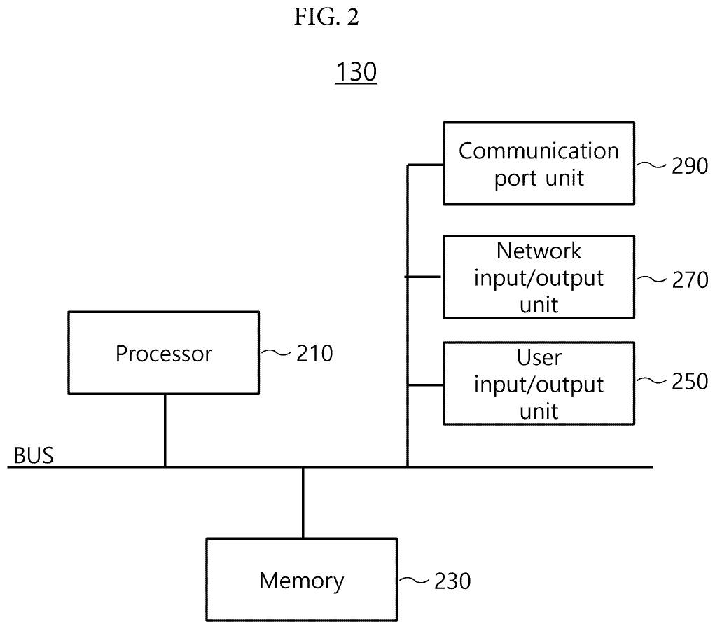

FIG. 2 is a diagram illustrating a system configuration of the speech data-based script processing apparatus of FIG. 1 according to one embodiment of the present invention.

Referring to FIG. 2, the speech data-based script processing apparatus 130 may include a processor 210, a memory 230, a user input/output unit 250, a network input/output unit 270, and a communication port unit 290.

The processor 210 may control overall operations of the speech data-based script processing apparatus 130, and may perform various functions by interacting with the memory 230 and the like.

The processor 210 may execute a speech data-based script processing procedure according to an embodiment of the present invention, may manage the memory 230 that is read or written during the execution, and may schedule synchronization timing between a volatile memory and a non-volatile memory included in the memory 230. The processor 210 may control overall operations of the speech data-based script processing apparatus 130, and may be electrically connected to the memory 230, the user input/output unit 250, the network input/output unit 270, and the communication port unit 290 to control data flows therebetween.

In addition, the processor 210 may control analysis of speech data according to a user request and detection and correction of errors in a converted script and a summary. The processor 210 may be implemented as a CPU (Central Processing Unit) or a GPU (Graphics Processing Unit) of the speech data-based script processing apparatus 130, and may include a processor architecture capable of parallel computation in order to support large-scale speech data processing and real-time conversion.

The memory 230 may include an auxiliary storage device implemented as a non-volatile memory such as an SSD (Solid State Disk) or an HDD (Hard Disk Drive) and used to store overall data required for the speech data-based script processing apparatus 130, and may include a main memory implemented as a volatile memory such as a RAM (Random Access Memory).

In addition, the memory 230 may store a set of instructions for performing a speech data-based script processing procedure by being executed by the processor 210 electrically connected thereto.

The memory 230 may store speech data input from a user, converted scripts, generated summaries, and modified script data, and may be utilized as training data for improving accuracy of script conversion by reflecting feedback data.

The user input/output unit 250 may include a device capable of receiving input from a user and outputting a converted script and a summary. For example, the user input/output unit 250 may include an input device such as a touch pad, a touch screen, a virtual keyboard, or a pointing device, and may include an output device such as a monitor or a touch screen. In one embodiment, the user input/output unit 250 may correspond to a computing device accessed through remote access, and in such a case, the speech data-based script processing apparatus 130 may be implemented as an independent server.

The network input/output unit 270 may provide a communication environment for connecting to a user terminal through a network, and may include, for example, an adapter for communication such as a LAN (Local Area Network), a MAN (Metropolitan Area Network), a WAN (Wide Area Network), and a VAN (Value Added Network). In addition, the network input/output unit 270 may be implemented to provide short-range wireless communication functions such as Wi-Fi and Bluetooth, or wireless communication functions of 4G or higher for wireless data transmission.

The communication port unit 290 may be implemented as a port mapping table that performs data routing in a process of transmitting and receiving data through a network. Here, the communication port unit 290 may assign a unique source port to each user terminal 110 in a process of transmitting and receiving speech data and converted script data, thereby managing data packet flows and optimizing transmission paths. In addition, the communication port unit 290 may manage converted scripts and feedback data separately in order to prevent data collisions between conversion processes executed in the script processing apparatus 130.

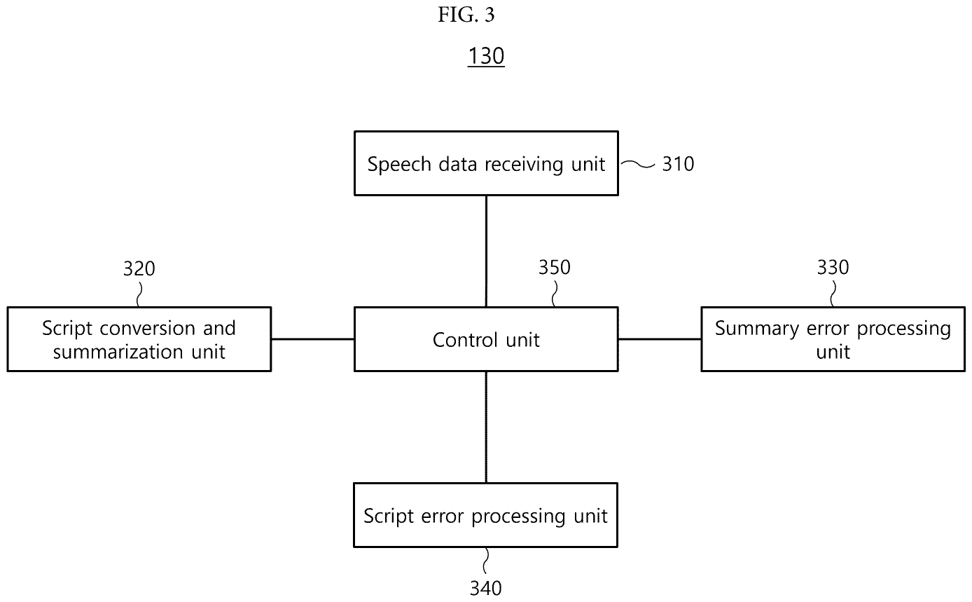

FIG. 3 is a diagram illustrating a functional configuration of the speech data-based script processing apparatus of FIG. 1 according to one embodiment of the present invention.

Referring to FIG. 3, the speech data-based script processing apparatus 130 includes a speech data receiving unit 310, a script conversion and summarization unit 320, a summary error processing unit 330, a script error processing unit 340, and a control unit 350.

In this regard, embodiments of the present invention do not necessarily include all of the above functional components at the same time, and depending on each embodiment, some of the above components may be omitted, or some or all of the above components may be selectively included and implemented. In addition, one embodiment of the present invention may be implemented as independent modules selectively including some of the above components, and a speech data-based script processing method may be performed through interoperation among the modules. Hereinafter, operations of each component will be described in detail.

The speech data receiving unit 310 may receive user speech data and transmit the received data to the script conversion and summarization unit 320. The speech data receiving unit 310 may be designed to process user speech input in various manners, and may include preprocessing functions for optimizing speech recognition performance.

The speech data receiving unit 310 may receive user speech data in real time, remove background noise, and extract a clear speech signal. The background noise removal technology may utilize a speech separation algorithm or a noise filtering technique to improve accuracy of the speech data.

The speech data receiving unit 310 may analyze speech characteristics such as intonation, pronunciation, and speed of a user so that more accurate conversion may be performed in a script conversion process. For example, when a user speaks at a fast speed, the speech data receiving unit 310 may detect the fast speed and correct the speech data to be converted at an appropriate speed, and when a user's intonation affects pronunciation of a specific word, the speech data receiving unit 310 may perform additional analysis so that the word may be more clearly recognized.

The speech data receiving unit 310 may receive user speech data from various input devices such as a smartphone, a tablet, a PC, and a wearable device, and may transmit the data to the script conversion and summarization unit 320 through a wired or wireless network. The speech data may be processed in a local environment, or a high-performance speech recognition model may be applied by utilizing a cloud server.

The script conversion and summarization unit 320 may perform a function of converting speech data input from the speech data receiving unit 310 into a script, detecting errors in the converted script, and generating a summary. The script conversion and summarization unit 320 may convert the script into embedding vectors by utilizing an artificial intelligence script model, and may evaluate a possibility of syntax errors and semantics errors by analyzing the converted embedding vectors. The script conversion and summarization unit 320 may reflect an evaluation result in a summary generation process, and may display sentences having a high possibility of errors using a specific style such as font, size, color, and underline so that a user may easily recognize the sentences.

The script conversion and summarization unit 320 may detect syntax errors and semantics errors separately and apply analysis techniques corresponding thereto. The script conversion and summarization unit 320 may generate multi-dimensional embedding vectors to detect syntax errors, and may analyze a specific dimension to detect inter-word spacing errors, sentence structure errors, and incomplete phrases. In addition, the script conversion and summarization unit 320 may evaluate semantic inconsistency by analyzing distances between embedding vectors in order to detect semantics errors, and may score a possibility of errors.

The script conversion and summarization unit 320 may perform an error detection function by utilizing natural language processing (NLP)-based analysis techniques. The script conversion and summarization unit 320 may apply morphological analysis, syntax tree parsing, and a deep learning-based grammar error detection model in order to detect syntax errors. In addition, the script conversion and summarization unit 320 may analyze contextual meanings by utilizing a Transformer-based language model and may apply a semantic matching technique for measuring similarity between sentences in order to detect semantics errors.

The script conversion and summarization unit 320 may apply a Korean morphological analyzer for detecting syntax errors to perform part-of-speech tagging for each word, and may detect sentence structure errors by utilizing a dependency parsing model. For example, when detecting that a connection between “weather” and “good” in a sentence “today weather very good” is grammatically incorrect, the script conversion and summarization unit 320 may provide a recommended correction. In addition, spacing and spelling errors may be detected by applying a deep learning-based Korean spelling checker module and a spacing correction algorithm.

The script conversion and summarization unit 320 may evaluate semantics errors by utilizing a Transformer-based pre-trained language model such as BERT or KoBERT. The script conversion and summarization unit 320 may calculate semantic similarity between a specific phrase of the summary and a corresponding phrase of the original script, and when the similarity is lower than a predetermined criterion, may determine the phrase as semantic inconsistency (semantics error). For example, when “this project is scheduled to be completed within three weeks” is converted into “this project will be completed after three weeks” in a summary, the script conversion and summarization unit 320 may determine that a semantic difference exists and may request user confirmation.

The script conversion and summarization unit 320 may generate a summary based on results of syntax and semantics error analyses. The script conversion and summarization unit 320 may apply a first style reflecting syntax error detection results to a specific phrase of the summary and may apply a second style reflecting semantics error detection results to a specific section. For example, when a user inputs speech stating “we discussed budget issues in today's meeting and decided to prepare a solution by next week,” the script conversion and summarization unit 320 may generate a summary such as “Meeting: budget issue discussion. Prepare solution (by next week).”

The summary error processing unit 330 is a component that supports modification of syntax errors and semantics errors of the summary based on user input. The summary error processing unit 330 may identify specific errors in the summary generated by the script conversion and summarization unit 320 and may highlight the errors using a specific style such as font, size, and color so that a user may recognize and modify the errors.

The summary error processing unit 330 may separately process syntax error phrases and semantics error phrases. Syntax error phrases may include spacing errors, spelling errors, and sentence structure errors, and may be displayed in the summary as first style texts such as underlined text or red-colored text. A user may directly modify the highlighted phrases, and the modified content may be reflected in the original script.

Semantics error phrases may include cases in which semantic inconsistency occurs in the summary, and phrases in which semantic errors are detected may be highlighted as second style texts such as text with a yellow background. A user may select one of provided alternative phrase options or may directly input a phrase to correct the error.

The summary error processing unit 330 may detect syntax errors by applying a Korean morphological analyzer and a dependency parsing model to identify sentence structure errors. By performing morphological analysis, components of a sentence may be decomposed, and portions including grammatical errors may be detected. In addition, the summary error processing unit 330 may utilize a Korean spelling checker module and a spacing correction algorithm to detect and correct spacing and spelling errors. The summary error processing unit 330 may perform syntactic structure analysis to analyze relationships between words in a sentence and detect sentence structure errors.

The summary error processing unit 330 may utilize a pre-trained language model, such as BERT or KoBERT, to detect semantics errors. The summary error processing unit 330 may evaluate semantic consistency between a specific phrase of a summary and a corresponding phrase of an original script, and when semantic similarity is low, may determine the phrase as semantic inconsistency (semantics error). The summary error processing unit 330 may request user confirmation for a phrase determined as a semantics error and may recommend an alternative phrase so that a more accurate expression may be selected.

For example, when a user utters “the meeting tomorrow has been changed to 3 p.m.” but the summary is converted into “the meeting tomorrow has been canceled at 3 p.m. ,” the summary error processing unit 330 may recognize a semantic difference between “has been changed” and “has been canceled,” and may notify a user of a possibility of an error by applying a specific style. The user may directly modify a phrase including an error or may select a recommended alternative phrase to correct the error.

The summary error processing unit 330 may improve quality of a converted script and enhance reliability of a summary based on a modified summary. A summary reflecting user feedback may contribute to deriving more refined results in a script conversion process.

The script error processing unit 340 may automatically correct errors of an original script by reflecting modifications made by the summary error processing unit 330, and may utilize feedback data as training data.

The script error processing unit 340 may feed back results of correction of syntax errors and semantics errors of a summary to the artificial intelligence script model, and may reflect conversion errors according to user speech characteristics in the model. In addition, the script error processing unit 340 may analyze syntax error phrases and semantics error phrases separately, and may convert feedback data into training data so that the artificial intelligence model may automatically detect and correct conversion errors.

The script error processing unit 340 may perform learning based on the feedback data, recognize repeatedly occurring errors, and optimize a conversion model so that the errors may be automatically corrected in a conversion process. For example, when a user repeatedly corrects a phrase “business report” to “business report document,” the script error processing unit 340 may support the AI model to learn the pattern so that the correction may be automatically reflected in a conversion process.

The script error processing unit 340 may perform morphological analysis and dependency parsing to correct grammatical errors for syntax error detection. In addition, the script error processing unit 340 may utilize a Transformer-based language model such as BERT or KoBERT to evaluate semantic similarity for semantics error detection, and may be configured to automatically correct semantics errors when the semantic similarity is lower than a predetermined criterion.

The script error processing unit 340 may analyze user speech data such as intonation, pronunciation, and speed during a feedback process, and may utilize the analyzed data to improve speech recognition performance and script conversion performance of the AI model. For example, the script error processing unit 340 may analyze a user's pronunciation habits, learn cases in which specific words are incorrectly converted, and correct conversion errors when the same words are input.

The script error processing unit 340 may perform not only a function of reflecting real-time feedback but also a function of converting existing recorded data into training data. In addition, the script error processing unit 340 may be optimized to perform stable conversion in various speech input environments, and may improve conversion accuracy through continuous model updates.

The control unit 350 may perform data processing and control operations among the speech data receiving unit 310, the script conversion and summarization unit 320, the summary error processing unit 330, and the script error processing unit 340.

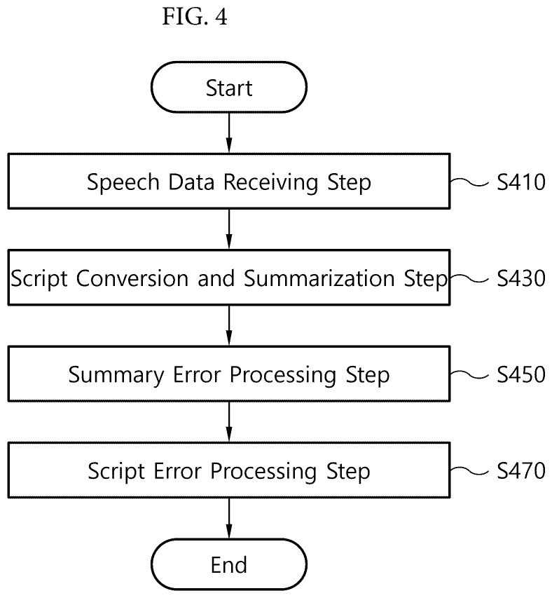

FIG. 4 is a flowchart illustrating a speech data-based script processing method performed by the speech data-based script processing apparatus of FIG. 1 according to one embodiment of the present invention.

Referring to FIG. 4, the speech data-based script processing apparatus 130 performs a speech data-based script processing procedure, and the speech data-based script processing procedure includes a speech data receiving step S410, a script conversion and summarization step S430, a summary error processing step S450, and a script error processing step S470.

The speech data receiving step S410 may perform a function of receiving speech data from the user terminal 110 and transmitting the received speech data to the script conversion and summarization step S430. The speech data receiving step S410 may include preprocessing functions such as background noise removal, speech signal enhancement, and intonation and pronunciation correction in order to stably process the speech data. The speech data receiving step S410 may operate in various input environments, and may receive data through a smartphone, a tablet, a computer, and other speech input devices. For example, when a user inputs speech through a smartphone during a meeting, the speech data receiving step S410 may collect the speech data in real time, apply noise filtering, and transmit the speech data to the script conversion and summarization step S430.

The script conversion and summarization step S430 may perform a function of converting the received speech data into a script and converting the converted script into a summary through an artificial intelligence script model. The script conversion and summarization step S430 may include a function of analyzing a possibility of syntax errors and semantics errors to improve accuracy of the summary. The script conversion and summarization step S430 may generate multi-dimensional embedding vectors and detect sentence structure errors and semantic errors through vector analysis. For example, when a user utters “the meeting is scheduled to be held between 3 o'clock and 4 o'clock,” but the speech is converted into “the meeting is scheduled to be canceled between 3 o'clock and 4 o'clock” during a script conversion process, the script conversion and summarization step S430 may detect the conversion as a semantics error and may highlight a phrase having a high possibility of an error.

The summary error processing step S450 may perform a function of supporting modification of syntax errors and semantics errors of the summary through user input. The summary error processing step S450 may detect a syntax error phrase in the summary and may display the phrase as a first style text such as underlined text or red-colored font. The summary error processing step S450 may allow a user to directly modify the highlighted phrase, and the modified data may be reflected in the script error processing step S470. In addition, the summary error processing step S450 may evaluate semantic consistency between the original script and the summary by utilizing a pre-trained language model such as BERT or KoBERT in order to detect semantics errors. For example, when a user inputs a sentence “budget adjustment is required,” but the summary is converted into “budget reduction is required,” the summary error processing step S450 may detect the phrase as a semantics error and may present a recommended correction.

The script error processing step S470 may perform a function of reflecting modifications made in the summary error processing step S450 in the original script and optimizing the artificial intelligence script model based on feedback data. The script error processing step S470 may utilize feedback data including syntax errors and semantics errors as training data so as to automatically correct repeatedly occurring errors. The script error processing step S470 may allow the artificial intelligence script model to be continuously updated by reflecting the feedback data. For example, when a user modifies a summary “the meeting schedule will be changed to Friday” into “the meeting schedule is Friday,” the script error processing step S470 may learn the modification so that correct conversion may be automatically performed when a similar expression is input in the future.

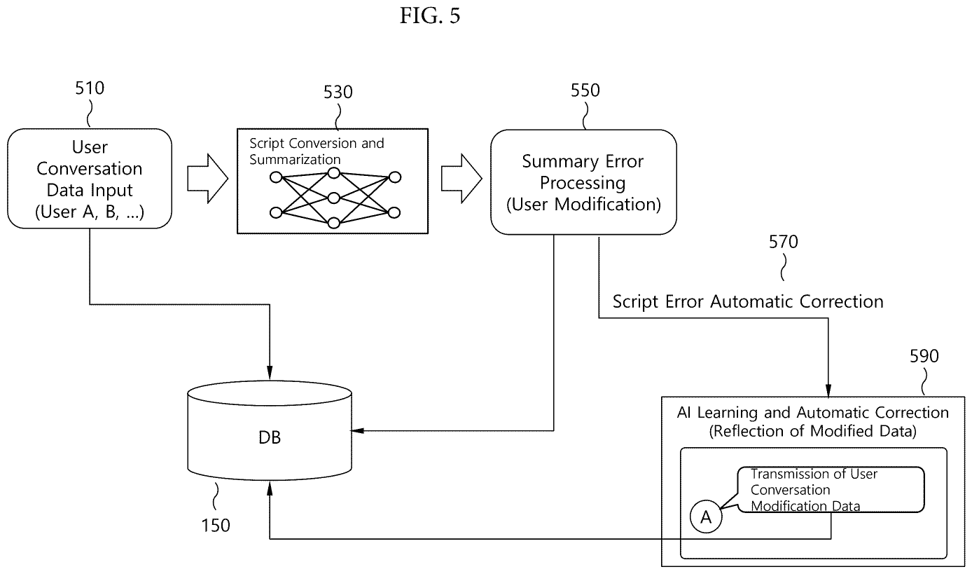

FIG. 5 is a diagram illustrating a script conversion and error correction process and an automatic correction process through AI learning performed by the speech data-based script processing apparatus of FIG. 1 according to one embodiment of the present invention.

Referring to FIG. 5, the speech data-based script processing apparatus 130 may perform a script conversion and error correction process including a user conversation data input step 510, a script conversion and summarization step 530, a summary error processing step 550, a script error automatic correction step 570, and an AI learning and automatic correction step 590.

In the user conversation data input step 510, the user terminal 110 inputs speech data, and the input speech data is stored in the database 150. The database 150 stores user conversation data and related information and provides the stored data so as to be referenced in the script conversion and summarization step 530.

In the script conversion and summarization step 530, the speech data-based script processing apparatus 130 converts the input speech data into a script and generates a summary by using an artificial intelligence script model based on the converted script. The script conversion and summarization step 530 generates embedding vectors to analyze a possibility of syntax errors and semantics errors, and phrases having a high possibility of errors are displayed in a specific style such as font, size, color, or underlining so that a user may easily recognize the errors.

In the summary error processing step 550, a user may check errors in the summary generated in the script conversion and summarization step 530 and may directly modify the errors. The summary error processing step 550 displays syntax errors and semantics errors as first style text and second style text, respectively, and the user may select highlighted error phrases and manually modify the phrases. The user's modification data is stored in the database 150 and is utilized in the script error automatic correction step 570.

In the script error automatic correction step 570, the script processing apparatus 130 automatically corrects errors in the original script based on the summary data modified by the user. The script error automatic correction step 570 analyzes a correspondence relationship between errors in the summary and the original script and automatically corrects portions including syntax errors and semantics errors, and the automatically corrected script is updated in the database 150.

In the AI learning and automatic correction step 590, the script processing apparatus 130 reflects the corrected script data in an artificial intelligence learning model so as to continuously improve conversion accuracy. The AI learning and automatic correction step 590 learns error patterns repeatedly modified by the user and adjusts the script conversion process so that the same errors do not occur in subsequent script conversion processes. In addition, feedback data is utilized to update syntax and semantics error detection models and to optimize performance of a speech recognition model.

The script conversion and error correction process described with reference to FIG. 5 may be performed in real time, and script conversion accuracy may be gradually improved by reflecting user feedback. The speech data-based script processing apparatus 130 supports optimization of user input data so as to generate more accurate scripts and summaries.

Although the preferred embodiments of the present invention have been described above, those skilled in the art will understand that various modifications and changes may be made to the present invention without departing from the spirit and scope of the present invention as set forth in the appended claims.

### Detailed Description of Main Elements

100: speech data-based script processing system
110: user terminal
130: speech data-based script processing apparatus
150: database
210: processor
230: memory
250: user input/output unit
270: network input/output unit
310: speech data receiving unit
320: script conversion and summarization unit
330: summary error processing unit
340: script error processing unit
350: control unit
510: user conversation data input step
530: script conversion and summarization step
550: summary error processing step
570: script error automatic correction step
590: AI learning and automatic correction step

What is claimed is:

1. A speech data-based script processing apparatus comprising: a speech data receiving unit configured to receive user speech data;
a script conversion and summarization unit configured to convert the speech data into a script and to generate a summary by inputting the script into an artificial intelligence script model;
a summary error processing unit configured to modify errors in the summary through user control; and
a script error processing unit configured to modify errors in the script by feeding back the errors of the summary to the script model.

2. The speech data-based script processing apparatus of claim 1, wherein the script conversion and summarization unit is configured to convert the script into an embedding vector through the artificial intelligence script model, analyze syntax and semantics of the script through the embedding vector, evaluate a possibility of errors in the summary, and generate the summary by reflecting a result of the evaluation.

3. The speech data-based script processing apparatus of claim 2, wherein the script conversion and summarization unit is configured to convert the script into multi-dimensional embedding vectors through the artificial intelligence script model, and to identify a possibility of syntax errors of the script by analyzing a specific dimension of the multi-dimensional embedding vectors.

4. The speech data-based script processing apparatus of claim 3, wherein the script conversion and summarization unit is configured to evaluate a possibility of semantics errors of the script based on distances between the multi-dimensional embedding vectors, and to score a possibility of errors of the script by combining results of the syntax and semantics analyses.

5. The speech data-based script processing apparatus of claim 2, wherein the script conversion and summarization unit is configured to reflect an evaluation result of syntax of the script as a first style text in a specific phrase of the summary, and to reflect semantics of the script as a second style text in a specific section of the summary.

6. The speech data-based script processing apparatus of claim 1, wherein the summary error processing unit is configured to manually modify a syntax error phrase of the summary by receiving user input.

7. The speech data-based script processing apparatus of claim 1, wherein the summary error processing unit is configured to receive an explanation through user speech, recommend at least one modified text for a semantics error phrase of the summary, and automatically modify the second style text.

8. The speech data-based script processing apparatus of claim 1, wherein the script error processing unit is configured to feed back errors of the summary to the artificial intelligence script model and to reflect conversion errors according to user speech characteristics in the artificial intelligence script model.

9. The speech data-based script processing apparatus of claim 8, wherein the script error processing unit is configured to feed back a specific phrase according to a syntax error of the summary and a specific section according to a semantics error of the summary to the artificial intelligence script model, such that the artificial intelligence script model automatically detects the conversion errors.

10. The speech data-based script processing apparatus of claim 9, wherein the script error processing unit is configured such that the artificial intelligence script model automatically modifies the script and the summary based on automatic detection of the conversion errors.

11. The speech data-based script processing apparatus of claim 8, wherein the script error processing unit is configured to derive speech characteristics based on intonation, pronunciation, or speed analyzed through the user speech data during the feedback process, and to reflect the speech characteristics as training data of the artificial intelligence script model.

12. The speech data-based script processing apparatus of claim 1, wherein the script error processing unit is configured to update the artificial intelligence script model based on an original script and a modified script.

13. A speech data-based script processing method performed in a speech data-based script processing apparatus, the method comprising:
receiving user speech data;
converting the speech data into a script and generating a summary by inputting the script into an artificial intelligence script model;
modifying errors in the summary through user control; and
modifying errors in the script by feeding back the errors of the summary to the script model.

14. The speech data-based script processing method of claim 13, wherein the converting the speech data into the script and generating the summary comprises converting the script into an embedding vector through the artificial intelligence script model, analyzing syntax and semantics of the script through the embedding vector, evaluating a possibility of errors in the summary, and generating the summary by reflecting a result of the evaluation.

15. The speech data-based script processing method of claim 13, wherein the modifying the errors in the summary comprises manually modifying a syntax error phrase of the summary by receiving user input.

16. The speech data-based script processing method of claim 13, wherein the modifying the errors in the script comprises feeding back errors of the summary to the artificial intelligence script model and reflecting conversion errors according to user speech characteristics in the artificial intelligence script model.
